(19) United States
(12) Patent Application Publication
(10) Pub. No.: US 2024/0383817 A1
(43) Pub. Date: Nov. 21, 2024

(54) INTEGRATED METHOD AND INTEGRATED SYSTEM FOR RESOURCE RECOVERY OF SOURCE-SEPARATED URINE

(71) Applicant: UNIVERSITY OF SCIENCE AND TECHNOLOGY BEIJING, Beijing (CN)

(72) Inventors: Zifu LI, Beijing (CN); Yaping LYU, Beijing (CN); Xuemei WANG, Beijing (CN); Xiaoqin ZHOU, Beijing (CN); Rui FENG, Beijing (CN); Xiuwei AO, Beijing (CN); Shikun CHENG, Beijing (CN)

(21) Appl. No.: 18/504,236

(22) Filed: Nov. 8, 2023

Related U.S. Application Data
(63) Continuation of application No. PCT/CN2023/102554, filed on Jun. 27, 2023.

(30) Foreign Application Priority Data
May 18, 2023 (CN) 202310562826.6

(51) Int. Cl. C05F 3/00; C05F 17/60

(52) U.S. Cl. CPC C05F 3/00; C05F 17/60

(57) ABSTRACT

Disclosed are an integrated method and an integrated system for resource recovery of source-separated urine. The integrated method for resource recovery of the source-separated urine includes: mixing the source-separated urine with an alkali metal peroxysulphate to obtain a mixture, and subjecting the mixture to evaporation-concentration by heating to obtain condensed water and a liquid compound fertilizer, where the liquid compound fertilizer includes urea, a phosphorus salt, and a potassium salt.

### CROSS REFERENCE TO RELATED APPLICATIONS

This application is a continuation of International Patent Application No. PCT/CN2023/102554, filed on Jun. 27, 2023, which claims priority to Chinese Patent Application No. CN202310562826.6, filed on May 18, 2023, the entire disclosures of which are incorporated herein by reference in their entireties.

### TECHNICAL FIELD

The present disclosure belongs to the field of sewage treatment, and in particular relates to an integrated method and an integrated system for resource recovery of source-separated urine.

### BACKGROUND

As a part of domestic sewage, urine generally needs to be transported to wastewater treatment plants for centralized treatment. Although urine accounts for less than 1% of domestic sewage, it contributes 87% of nitrogen, 50% of phosphorus, and 54% of potassium in the domestic sewage, respectively. If being directly discharged into a wastewater treatment plant or discharged into the environment without treatment, urine containing high concentrations of nitrogen, phosphorus, and potassium resources can increase a load of nitrogen and phosphorus removal in the wastewater treatment plant, or cause eutrophication of surface water and groundwater environment; meanwhile, the discharged urine leads to waste of nitrogen, phosphorus and potassium resources.

At present, urine can be separated from the source through a urine source separation technology, such that the urine does not mix with domestic sewage and can be treated separately, thereby recovering nitrogen, phosphorus, and potassium from the urine. Urease can be produced by variety of microorganisms in urine, which can rapidly hydrolyze urea and generate ammonia nitrogen. On one hand, the volatility of ammonia nitrogen will result in nitrogen loss and reduce recovery efficiency of nitrogen. On the other hand, the volatilization of ammonia nitrogen causes unpleasant odor and atmospheric contamination during the treatment. Meanwhile, if pathogenic microorganisms and antibiotics contained in the source-separated urine are not removed, these substances can directly return to soil along with reuse of the urine, leading to migration of these pathogenic microorganisms and antibiotics in urine into the nature. This is detrimental to the growth of crops as well as being harmful to the environment and ecology.

### SUMMARY

An object of the present disclosure is to provide an integrated method and an integrated system for resource recovery of source-separated urine. In the present disclosure, the method results in a high inactivation efficiency of pathogenic microorganisms and a high removal efficiency of antibiotics, and truly realizes urine harmless treatment, complete resource recovery, and zero discharge. Moreover, the method shows a short recovery process and simple operation, and is suitable for industrial application.

To achieve the above object, the present disclosure provides the following technical solutions:

The present disclosure provides an integrated method for resource recovery of source-separated urine, including the following steps:
mixing the source-separated urine with an alkali metal peroxysulphate to obtain a mixture, and then subjecting the mixture to evaporation-concentration by heating to obtain condensed water and a liquid compound fertilizer, wherein the liquid compound fertilizer includes urea, a phosphorus salt, and a potassium salt.

In some embodiments, the alkali metal peroxysulphate is potassium peroxysulphate; and
a mass ratio of the alkali metal peroxysulphate to the source-separated urine is in a range of (5.4×10−3−8.1×10−3):1.

In some embodiments, the evaporation-concentration is performed by vacuum evaporation-concentration at a temperature of 45° C. to 55° C.

In some embodiments, the vacuum evaporation-concentration is conducted at a vacuum degree of ≤−0.09 MPa.

In some embodiments, the evaporation-concentration is conducted to reach a concentration factor of ≥19.

In some embodiments, the liquid compound fertilizer contains 50,000 mg/L-80,000 mg/L of total nitrogen, 1,000 mg/L-5,000 mg/L of total phosphorus, and 8,000 mg/L-20,000 mg/L of potassium.

The present disclosure further provides an integrated system for resource recovery of source-separated urine, including:
an evaporator 1 equipped with a liquid inlet, a gas outlet, and a liquid outlet;
a condenser 2 having a gas inlet in communication with the gas outlet of the evaporator 1;
a dosing unit 3 in communication with the liquid inlet of the evaporator 1; and
a source separation toilet 8 in communication with the liquid inlet of the evaporator 1; and
a flow sensor 4, which is provided on a pipe that connects the evaporator 1 and the source separation toilet 8,
wherein the flow sensor 4 is configured to sense a mass of the source-separated urine entering the evaporator 1 from the source separation toilet 8, and then to control the dosing unit 3 to add a corresponding mass of the alkali metal peroxysulphate; and
the flow sensor 4 is further configured to control starting of the evaporator 1.

In some embodiments, the condenser 2 is further provided with a liquid outlet; and the system for integrated resource recovery of source-separated urine further includes a condensed water storage tank 5 having a liquid inlet in communication with the liquid outlet of the condenser 2.

In some embodiments, the system further includes a concentrated liquid storage tank 6 having a liquid inlet in communication with the liquid outlet of the evaporator 1.

In some embodiments, the system further includes a solar collector 7, wherein the solar collector 7 is configured to provide heat for evaporation-concentration in the evaporator 1.

The present disclosure provides an integrated method for resource recovery of source-separated urine, including the following steps: mixing the source-separated urine with an alkali metal peroxysulphate to obtain a mixture, and then subjecting the mixture to evaporation-concentration by heating to obtain condensed water and a liquid compound fertilizer, wherein the liquid compound fertilizer includes urea, a phosphorus salt, and a potassium salt. In the present disclosure, the alkali metal peroxysulphate is used as an externally-added reagent for the source-separated urine. The alkali metal peroxysulphate is heated and activated to produce sulfate radicals and hydroxyl radicals, which further react with Cl−, NH4+, and HCO3− in urine to produce chlorine radicals, reactive nitrogen species, and carbonate radicals. These free radicals are oxidative and can destroy the structure of urease, such that the urease loses enzymatic activity, thereby preventing the urea from being hydrolyzed. Meanwhile, these free radicals can also destroy urease-producing microorganisms in urine, inhibit the production of urease, and avoid the hydrolysis of urea from the source. In addition, pathogenic microorganisms, antibioticse, as well as resistance genes in urine can be degraded by free radicals due to its strong oxidizing property. In summary, through treating with activated peroxysulphate (reaction therebetween), urine can be stabilized completely by inactivation of urease activity and inhibition urea hydrolysis and pathogenic microorganisms and antibiotics in urine are synergistically removed and degraded. Therefore, the urine has been evaporated and concentrated efficiently, and condensed water and a liquid compound fertilizer that can be safely reused are obtained. Therefore, the method achieves a treatment integrating urine stabilization, harmlessness, and resource recovery, has a short recovery process and simple operations, and is suitable for industrial application. The results of examples show that the liquid compound fertilizer obtained by the method has a pathogenic microorganism inactivation efficiency of not less than 99%, an antibiotic removal efficiency of not less than 99%, and a water recovery rate of not less than 95%.

The present disclosure further provides an integrated system for resource recovery of source-separated urine, including: an evaporator 1 provided with a liquid inlet, a gas outlet, and a liquid outlet; a condenser 2 with a gas inlet in communication with the gas outlet of the evaporator 1; a dosing unit 3 in communication with the liquid inlet of the evaporator 1; a source separation toilet 8 in communication with the liquid inlet of the evaporator 1; and a flow sensor 4, which is provided on a pipe that connects the evaporator 1 and the source separation toilet 8, wherein the flow sensor 4 is configured to sense a mass of the source-separated urine entering the evaporator 1 from the source separation toilet 8, and then to control the dosing unit 3 to add a corresponding mass of the alkali metal peroxysulphate; and the flow sensor 4 is further configured to control starting of the evaporator 1. In the present disclosure, the system includes the evaporator 1. The evaporator 1 realizes an integrated treatment of urine stabilization, harmlessness, and resource recovery, and effectively simplifies a flow of the reaction system. Moreover, the flow sensor 4 can realize accurate control of the amount of the externally-added reagent and starting of the evaporator, which not only reduces cost of urine recovery, but also avoids the secondary pollution of reagents, as well as realizes the automatic processing of source-separated urine.

### BRIEF DESCRIPTION OF THE DRAWINGS

FIG. 1 shows a schematic diagram of the integrated system for resource recovery of source-separated urine according to an embodiment of the present disclosure; where
in FIG. 1, 1 represents an evaporator; 2 represents a condenser; 3 represents a dosing unit; 4 represents a flow sensor; 5 represents a condensed water storage tank; 6 represents a concentrated liquid storage tank; 7 represents a solar collector; and 8 represents a source separation toilet.

FIG. 2 shows a comprehensive utilization diagram of the integrated method for resource recovery of source-separated urine according to an embodiment of the present disclosure.

### DETAILED DESCRIPTION OF THE EMBODIMENTS

The present disclosure provides an integrated method for resource recovery of source-separated urine, including the following steps:
mixing the source-separated urine with an alkali metal peroxysulphate to obtain a mixture, and subjecting the mixture to evaporation-concentration by heating to obtain condensed water and a liquid compound fertilizer, wherein the liquid compound fertilizer includes urea, a phosphorus salt, and a potassium salt.

In the present disclosure, unless otherwise specified, all raw materials/components for preparation are commercially available products well known to those skilled in the art.

In the present disclosure, there is no special requirement on a source of the source-separated urine.

In some embodiments of the present disclosure, the alkali metal peroxysulphate is potassium peroxysulphate.

In some embodiments of the present disclosure, the alkali metal peroxysulphate is used in the form of an aqueous solution of the alkali metal peroxysulphate. There is no special requirement on a concentration of the aqueous solution of the alkali metal peroxysulphate.

In some embodiments of the present disclosure, a mass ratio of the alkali metal peroxysulphate to the source-separated urine is in a range of (5.4×10−3−8.1×10−3):1, and preferably (6×10−3−8×10−3):1.

In some embodiments of the present disclosure, the mixing is conducted under stirring at a rotation speed of 100 r/min to 120 r/min.

In some embodiments of the present disclosure, the evaporation-concentration is performed by vacuum evaporation-concentration at a temperature of 45° C. to 55° C., and preferably at a temperature of 46° C. to 52° C.

In some embodiments of the present disclosure, the evaporation-concentration is conducted at a vacuum degree of ≤−0.09 MPa, and preferably −0.09 MPa.

In some embodiments of the present disclosure, after the source-separated urine and the alkali metal peroxysulphate are mixed in a continuous or batch manner, and the evaporation-concentration is conducted in a continuous or batch manner.

In some embodiments of the present disclosure, a hydraulic retention time for evaporation-concentration of the mixture obtained by mixing the source-separated urine with the alkali metal peroxysulphate ranges from 60 min to 80 min.

In some embodiments of the present disclosure, the evaporation-concentration is conducted to reach a concentration factor of ≥19. In the present disclosure, the concentration factor for the evaporation-concentration is a volume ratio of the source-separated urine before the concentration to the liquid compound fertilizer obtained after concentration.

In the present disclosure, the liquid compound fertilizer is a compound fertilizer containing three types of nutrients: nitrogen (urea), phosphorus, and potassium.

In some embodiments of the present disclosure, the liquid compound fertilizer contains 50,000 mg/L to 80,000 mg/L of total nitrogen (preferably 55,000 mg/L to 75,000 mg/L), 1,000 mg/L to 5,000 mg/L of total phosphorus (preferably 1,500 mg/L to 4,500 mg/L), and 8,000 mg/L to 20,000 mg/L of potassium (preferably 8,500 mg/L to 15,000 mg/L).

In the present disclosure, the condensed water meets the water reuse standard “The reuse of urban recycling water—Water quality standard for urban miscellaneous use” (GB/T 18920-2020), and it can also meet the global water reused standard, such as “2012 Guidelines for water reuse EPA/600/R-12/618” and “Canadian Guidelines for domestic reclaimed water for use in toilet flushing and urinal flushing H128-1/10-602E”.

As shown in FIG. 1, the present disclosure further provides an integrated system for resource recovery of source-separated urine, including:
an evaporator 1 provided with a liquid inlet, a gas outlet, and a liquid outlet;
a condenser 2 having a gas inlet in communication with the gas outlet of the evaporator 1;
a dosing unit 3 in communication with the liquid inlet of the evaporator 1;
a source separation toilet 8 in communication with the liquid inlet of the evaporator 1; and
a flow sensor 4, which is provided on a pipe that connects the evaporator 1 and the source separation toilet 8,
wherein the flow sensor 4 is configured to sense a mass of the source-separated urine entering the evaporator 1 from the source separation toilet 8, and then to control the dosing unit 3 to add a corresponding mass of the alkali metal peroxysulphate; and
the flow sensor 4 is further configured to control starting of the evaporator 1.

The present disclosure provides an integrated system for resource recovery of source-separated urine, including: an evaporator 1 provided with a liquid inlet, a gas outlet, and a liquid outlet.

In one or more embodiments of the present disclosure, the evaporator 1 is a negative-pressure rotary evaporator.

In one or more embodiments of the present disclosure, the evaporator 1 includes a first liquid inlet and a second liquid inlet.

In the present disclosure, the integrated system for resource recovery of source-separated urine includes a source separation toilet 8. A urine separation outlet of the source separation toilet 8 communicates with the first liquid inlet of the evaporator 1.

In the present disclosure, the integrated system for resource recovery of source-separated urine includes a condenser 2 with a gas inlet in communication with the gas outlet of the evaporator 1.

In one or more embodiments of the present disclosure, the condenser 2 is further provided with a liquid outlet.

In the present disclosure, the condenser 2 is configured to condense water vapor obtained in the evaporator 1 to obtain condensed water.

In some embodiments of the present disclosure, cooling water required during the condensation in condenser 2 is the condensed water from the condensed water storage tank 5.

In the present disclosure, the condensed water in the condensed water storage tank 5 has two functions. Firstly, it can provide cooling water for the condensation of water vapor in the evaporator 1. Secondly, it can be used as heat-transfer medium for evaporator 1 after being heated by solar collector 7. Therefore, the integrated system for resource recovery of source-separated urine does not require external condensed water or heat exchange water.

In the present disclosure, the integrated system for resource recovery of source-separated urine includes a dosing unit 3 in communication with the liquid inlet of the evaporator 1.

In one or more embodiments of the present disclosure, a liquid outlet of the dosing unit 3 communicates with the second liquid inlet of the evaporator 1.

In the present disclosure, the dosing unit is configured to add an alkali metal peroxysulphate to the source-separated urine.

In the integrated system for resource recovery of source-separated urine according to the present disclosure, a flow sensor 4 is provided on a pipe that connects the evaporator 1 and the source separation toilet 8.

In the present disclosure, the flow sensor 4 is configured to sense a mass of the source-separated urine entering the evaporator 1 from the source separation toilet 8, and then to control the dosing unit 3 to add a corresponding mass of the alkali metal peroxysulphate; and the flow sensor 4 is further configured to control starting of the evaporator 1. In some embodiments, the flow sensor 4 can also adjust a rotational speed of the evaporator 1 after it is started according to a mass of the source-separated urine entering the evaporator 1.

In some embodiments of the present disclosure, the flow sensor 4 controls a feeding amount of a reagent solution from the dosing unit according to the flow (or mass) of the source-separated urine entering the evaporator 1.

In some embodiments of the present disclosure, the integrated system for resource recovery of source-separated urine further includes a condensed water storage tank 5 with a liquid inlet in communication with the liquid outlet of the condenser 2.

In some embodiments of the present disclosure, the condensed water storage tank 5 is configured to store the condensed water obtained from the evaporation-concentration of the source-separated urine.

In some embodiments of the present disclosure, the integrated system for resource recovery of source-separated urine further includes a concentrated liquid storage tank 6 with a liquid inlet in communication with the liquid outlet of the evaporator 1.

In some embodiments of the present disclosure, the concentrated liquid storage tank 6 is configured to store the liquid compound fertilizer obtained from source-separated urine by evaporation-concentration.

In some embodiments of the present disclosure, the integrated system for resource recovery of source-separated urine further includes a solar collector 7, wherein the solar collector 7 is configured to provide heat for evaporation-concentration in the evaporator 1.

In one or more embodiments of the present disclosure, water is heated by the solar collector 7 to obtain water vapor, and the water vapor obtained is used for heating the evaporator 1.

In some embodiments of the present disclosure, the water used is condensed water.

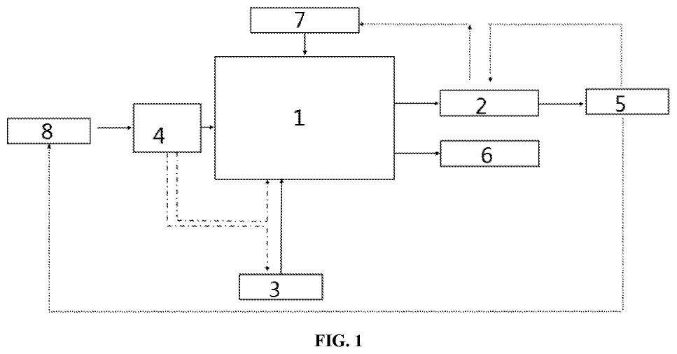

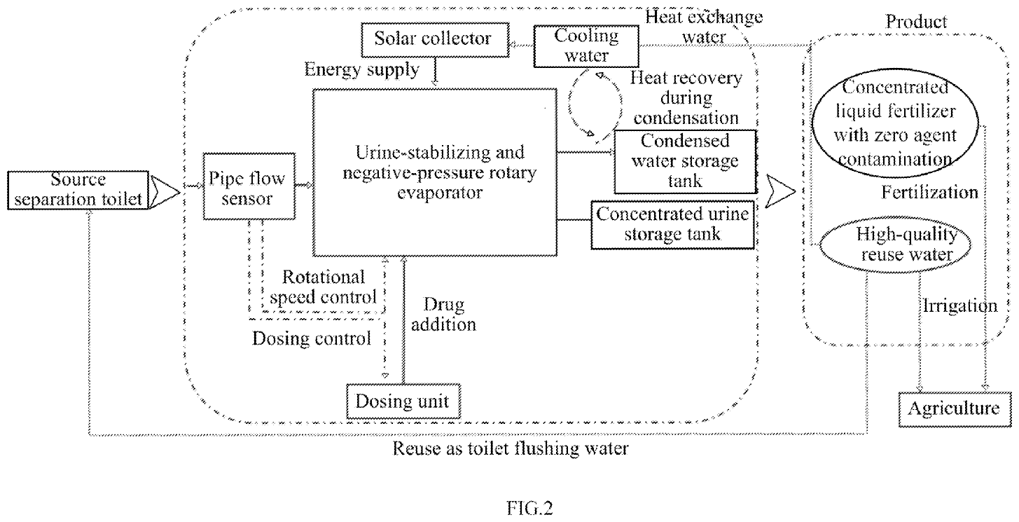

As shown in FIG. 2, the condensed water obtained by the integrated method for resource recovery of source-separated urine is recovered and reused as heat-transfer medium of the solar collector 7, condensation of the condenser 2, flushing of the source separation toilet 8, and agricultural irrigation. The liquid compound fertilizer obtained by the integrated method for resource recovery of source-separated urine can be used for agricultural fertilization.

In the present disclosure, the integrated method and the integrated system for resource recovery of source-separated urine could achieve the harmlessness and resource recycle of the source-separated urine. The integrated system for resource recovery of source-separated urine includes a source separation toilet 8, a solar collector 7, a pipe flow sensor 4, a dosing unit 3, a urine-stabilizing and negative-pressure rotary evaporator 1, a condenser 2, a condensed water storage tank 5, and a concentrated urine storage tank 6. The source-separated urine output from the source separation toilet 8 directly enters the urine-stabilizing and negative-pressure rotary evaporator 1. The urine-stabilizing and negative-pressure rotary evaporator 1 can achieve urine stabilization, urine harmlessness, and urine resource recovery simultaneously. The source-separated urine is mixed with a reagent (i.e., an alkali metal peroxysulphate) and heated in the evaporator 1, and the reagent is thermally activated to generate sulfate radicals and hydroxyl radicals, which are further reacted with Cl−, NH4+, and HCO3− to produce active chlorine free radicals, active nitrogen free radicals, and carbonate free radicals. These free radicals can oxidize urease, destroy the structure of urease, and thereby inhibit the activity of urease, as well as destroy the urease-producing microorganisms in urine to prevent the production of urease. In addition, pathogenic microorganisms, antibiotics, as well as resistance genes in urine can be degraded by free radicals due to its strong oxidizing property. The reaction under mixing can inhibit the activity of urease and the hydrolysis of urea, thereby stabilizing urine, and can also synergistically remove and degrade pathogenic microorganisms, antibiotics, and resistance genes in urine. Hence, urine can be efficiently evaporated and concentrated under negative-pressure and high-temperature condition, which produces high-quality condensed water and safe liquid compound fertilizer rich in urea, phosphorus, and potassium. The condensed water and liquid compound fertilizer can be reused for agricultural production. Additionally, the condensed water can be used as heat-transfer medium between the solar collector and the urine-stabilizing and negative-pressure rotary evaporator in this system, cooling water in the condensation, and flushing water for toilet. This system makes it possible to integrate urine stabilization, harmlessness, and resource recycle in one system, which greatly simplifies the urine treatment and realizes the short-process treatment of multiple resources recovery in the source-separated urine, thereby achieving harmless urine, full resource recovery, and zero discharge.

In order to further illustrate the present disclosure, the technical solutions according to the present disclosure will be described in detail below in conjunction with accompanying drawings and examples, but they should not be construed as limiting the scope of the present disclosure.

### Example 1

According to a recovery system shown in FIG. 1, source-separated urine obtained from the source separation toilet 8 was transported to a negative-pressure rotary evaporator 1 through a pipe. The potassium peroxysulphate in the dosing unit 3 was transported to the negative-pressure rotary evaporator 1 through a pipe. A flow rate of a potassium peroxysulphate aqueous solution was controlled by a pipe flow sensor 4 provided on the pipe, such that a mass ratio of the potassium peroxysulphate to the source-separated urine was at (5.4×10−3):1. The urine was treated in the negative-pressure rotary evaporator 1 (the heat was supplied by the solar collector 7), which was operated at a temperature of 45° C., a vacuum degree of −0.09 MPa and a rotational speed of 120 r/min. The evaporation-concentration was conducted until a concentration factor of the source-separated urine was 19. The obtained water vapor was condensed by the condenser 2 and the resulting condensed water was stored in the condensed water storage tank 5, while liquid compound fertilizer obtained from the evaporation-concentration was stored in the concentrated liquid storage tank 6.

The liquid compound fertilizer contained 50,000 mg/L of total nitrogen (TN), 5,000 mg/L of total phosphorus (TP), and 20,000 mg/L of potassium (K). The recovery rates of the TN, TP, and K all reached 95%. The inactivation efficiency of pathogenic microorganisms was 99%, and removal efficiency of antibiotics was 99%.

The condensed water met the water reuse standard “The reuse of urban recycling water—Water quality standard for urban miscellaneous use” (GB/T 18920-2020), and it can also meets the global water reused standard, such as “2012 Guidelines for water reuse EPA/600/R-12/618” and “Canadian Guidelines for domestic reclaimed water for use in toilet flushing and urinal flushing H128-1/10-602E”.

### Example 2

According to a recovery system shown in FIG. 1, source-separated urine obtained from the source separation toilet 8 was transported to a negative-pressure rotary evaporator 1 through a pipe. The potassium peroxysulphate in the dosing unit 3 was transported to the negative-pressure rotary evaporator 1 through a pipe. A flow rate of a potassium peroxysulphate aqueous solution was controlled by the pipe flow sensor 4 provided on the pipe, such that a mass ratio of the potassium peroxysulphate to the source-separated urine was at (8.1×10−3):1. The urine was treated in the negative-pressure rotary evaporator 1 (the heat was supplied by the solar collector 7), which was operated at a temperature of 55° C., a vacuum degree of −0.09 MPa and a rotational speed of 120 r/min. The evaporation-concentration was conducted until a concentration factor of the source-separated urine was 19. The obtained water vapor was condensed by the condenser 2 and the resulting condensed water was stored in the condensed water storage tank 5, while liquid compound fertilizer obtained by evaporation-concentration was stored in the concentrated liquid storage tank 6.

The liquid compound fertilizer contained 80,000 mg/L of total nitrogen, 4,000 mg/L of total phosphorus, and 15,000 mg/L of potassium. The recovery rates of the TN, TP, and K all reached 98%. The inactivation efficiency of pathogenic microorganisms was 99%, and removal efficiency of antibiotics was 99%.

The condensed water met the water reuse standard “The reuse of urban recycling water—Water quality standard for urban miscellaneous use” (GB/T 18920-2020), and it can also meets the global water reused standard, such as “2012 Guidelines for water reuse EPA/600/R-12/618” and “Canadian Guidelines for domestic reclaimed water for use in toilet flushing and urinal flushing H128-1/10-602E”.

### Example 3

According to a recovery system shown in FIG. 1, source-separated urine obtained from the source separation toilet 8 was transported to a negative-pressure rotary evaporator 1 through a pipe. The potassium peroxysulphate in the dosing unit 3 was transported to the negative-pressure rotary evaporator 1 through a pipe. A flow rate of a potassium peroxysulphate aqueous solution was controlled by the pipe flow sensor 4 provided on the pipe, such that a mass ratio of the potassium peroxysulphate to the source-separated urine was at (7×10−3):1. The urine was treated in the negative-pressure rotary evaporator 1 (the heat was supplied by the solar collector 7), which was operated at a temperature of 50° C., a vacuum degree of −0.09 MPa and a rotational speed of 120 r/min. The evaporation-concentration was conducted until a concentration factor of the source-separated urine was 19. The obtained water vapor was condensed by the condenser 2 and the resulting condensed water was stored in the condensed water storage tank 5, while liquid compound fertilizer obtained by evaporation-concentration was stored in the concentrated liquid storage tank 6.

The liquid compound fertilizer contained 70,000 mg/L of total nitrogen, 4,500 mg/L of total phosphorus, and 10,000 mg/L of potassium. The recovery rates of the TN, TP, and K all reached 97%. The inactivation efficiency of pathogenic microorganisms was 99%, and a removal efficiency of antibiotics was 99%.

The condensed water met the national water reuse standard “The reuse of urban recycling water—Water quality standard for urban miscellaneous use” (GB/T 18920-2020), and it can also meets the global water reused standard, such as “2012 Guidelines for water reuse EPA/600/R-12/618” and “Canadian Guidelines for domestic reclaimed water for use in toilet flushing and urinal flushing H128-1/10-602E”.

### Example 4

According to a recovery system shown in FIG. 1, source-separated urine obtained from the source separation toilet 8 was transported to a negative-pressure rotary evaporator 1 through a pipe. The potassium peroxysulphate in the dosing unit was transported to the negative-pressure rotary evaporator 1 through a pipe. A flow rate of a potassium peroxysulphate aqueous solution was controlled by the pipe flow sensor 4 provided on the pipe, such that a mass ratio of the potassium peroxysulphate to the source-separated urine was at (6.5×10−3):1. The urine was treated in the negative-pressure rotary evaporator 1 (the heat was supplied by the solar collector 7), which was operated at a temperature of 45° C., a vacuum degree of −0.09 MPa and a rotational speed of 120 r/min. The evaporation-concentration was conducted until a concentration factor of the source-separated urine was 19. The obtained water vapor was condensed by the condenser 2 and the resulting condensed water was stored in the condensed water storage tank 5, while liquid compound fertilizer obtained by evaporation-concentration was stored in the concentrated liquid storage tank 6.

The liquid compound fertilizer contained 60,000 mg/L of total nitrogen, 3,000 mg/L of total phosphorus, and 12,000 mg/L of potassium. The recovery rates of the TN, TP and K all reached 96%. The inactivation efficiency of pathogenic microorganisms was 99%, and a removal efficiency of antibiotics was 99%.

The condensed water met the national water reuse standard “The reuse of urban recycling water—Water quality standard for urban miscellaneous use” (GB/T 18920-2020), and it can also meets the global water reused standard, such as “2012 Guidelines for water reuse EPA/600/R-12/618” and “Canadian Guidelines for domestic reclaimed water for use in toilet flushing and urinal flushing H128-1/10-602E”.

Although the present disclosure is described in detail in conjunction with the foregoing embodiments, they are only a part of, not all of, the embodiments of the present disclosure. Other embodiments can be obtained based on these embodiments without creative efforts, and all of these embodiments shall fall within the scope of the present disclosure.

What is claimed is:

1. An integrated method for resource recovery of source-separated urine, comprising:
mixing the source-separated urine with an alkali metal peroxysulphate to obtain a mixture; and
subjecting the mixture to evaporation-concentration by heating to obtain condensed water and a liquid compound fertilizer;
wherein the liquid compound fertilizer comprises urea, a phosphorus salt, and a potassium salt.

2. The integrated method for resource recovery of the source-separated urine of claim 1, wherein:
the alkali metal peroxysulphate is potassium peroxysulphate; and
a mass ratio of the alkali metal peroxysulphate to the source-separated urine is in a range of (5.4×10−3−8.1×10−3):1.

3. The integrated method for resource recovery of the source-separated urine of claim 1, wherein the evaporation-concentration is performed by vacuum evaporation-concentration at a temperature of 45° C. to 55° C.

4. The integrated method for resource recovery of the source-separated urine of claim 3, wherein the vacuum evaporation-concentration is conducted at a vacuum degree of ≤−0.09 MPa.

5. The integrated method for resource recovery of the source-separated urine of claim 1, wherein the evaporation-concentration is conducted to reach a concentration factor of ≥19.

6. The integrated method for resource recovery of the source-separated urine of claim 1, wherein the mixing is conducted under stirring at a rotation speed of 100 r/min to 120 r/min.

7. The integrated method for resource recovery of the source-separated urine of claim 1, wherein a hydraulic retention time for the evaporation-concentration of the mixture obtained by mixing the source-separated urine with the alkali metal peroxysulphate ranges from 60 min to 80 min.

8. The integrated method for resource recovery of the source-separated urine of claim 1, wherein the liquid compound fertilizer contains 50,000 mg/L to 80,000 mg/L of total nitrogen, 1,000 mg/L to 5,000 mg/L of total phosphorus, and 8,000 mg/L to 20,000 mg/L of potassium.

9. An integrated system for resource recovery of source-separated urine, comprising:
an evaporator provided with a liquid inlet, a gas outlet, and a liquid outlet;
a condenser having a gas inlet in communication with the gas outlet of the evaporator;
a dosing unit in communication with the liquid inlet of the evaporator;
a source separation toilet in communication with the liquid inlet of the evaporator; and
a flow sensor provided on a pipe that connects the evaporator and the source separation toilet,
wherein:
the flow sensor is configured to sense a mass of the source-separated urine entering the evaporator from the source separation toilet, and then to control the dosing unit to add a corresponding mass of the alkali metal peroxysulphate; and
the flow sensor is further configured to control starting of the evaporator.

10. The integrated system for resource recovery of the source-separated urine of claim 9, wherein:
the condenser is further provided with a liquid outlet; and
the integrated system for resource recovery of the source-separated urine further comprises a condensed water storage tank having a liquid inlet in communication with the liquid outlet of the condenser.

11. The integrated system for resource recovery of the source-separated urine of claim 9, further comprising a concentrated liquid storage tank having a liquid inlet in communication with the liquid outlet of the evaporator.

12. The integrated system for resource recovery of the source-separated urine of claim 9, further comprising a solar collector, wherein the solar collector is configured to provide heat for evaporation-concentration in the evaporator.

13. The integrated method for resource recovery of the source-separated urine of claim 2, wherein the evaporation-concentration is performed by vacuum evaporation-concentration at a temperature of 45° C. to 55° C.

14. The integrated method for resource recovery of the source-separated urine of claim 2, wherein the evaporation-concentration is conducted to reach a concentration factor of ≥19.
